(19) United States
(12) Patent Application Publication
(10) Pub. No.: US 2007/0236521 A1
(43) Pub. Date: Oct. 11, 2007

(54) Droplet ejection head drive apparatus and inkjet recording apparatus

(75) Inventor: Yoshinao Kondoh, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/546,728

(22) Filed: Oct. 12, 2006

(30) Foreign Application Priority Data
Apr. 5, 2006 (JP) 2006-104488

(51) Int. Cl. B41J 29/38

(52) U.S. Cl. 347/10

(57) ABSTRACT

A droplet ejection head drive apparatus including a capacitive device that ejects droplets, plural electrodes to which at least three kinds of voltage values are input, plural switch elements that are provided corresponding to each of the electrodes and that apply the voltage values to the capacitive device. Bidirectional switch elements are used for at least one of either the switch elements corresponding to the electrode(s) to which a voltage value is input other than the maximum voltage value or the switch element(s) corresponding to the electrode(s) to which a voltage value is input other than the maximum and minimum voltage values.

### BACKGROUND

1. Technical Field

The present invention relates to a droplet ejection head drive apparatus and an inkjet recording apparatus, particularly to the droplet ejection head drive apparatus which ejects a droplet by vibration of a capacitive device such as a piezoelectric element.

2. Related Art

In the droplet ejection head drive apparatus such as an inkjet printer in which a piezoelectric element is used as an actuator to eject the droplet, when emphasis is put on a high-quality image, there is well known a droplet ejection apparatus on which the piezoelectric element is driven using an analog waveform. In the analog waveform, the droplet may freely be ejected by freely controlling a liquid level (meniscus).

On the other hand, there is also a droplet ejection head drive apparatus in which the piezoelectric element is driven by using a rectangular pulse waveform including plural kinds of voltage levels, and miniaturized and low-cost droplet ejection head drive apparatus is already proposed.

### SUMMARY

In consideration of the above circumstances, the present invention provides a droplet ejection head drive apparatus and inkjet recording apparatus.

According to an aspect of the invention, there is provided a droplet ejection head drive apparatus including: a capacitive device for ejecting a droplet; a plurality of electrodes to which at least three kinds of voltage values are inputted; a plurality of switch elements that are provided corresponding to each of the electrodes, the plurality of switch elements applying the voltage values to the capacitive device, and in the plurality of switch elements bidirectional switch element(s) are used for at least one of either the switch elements corresponding to the electrodes to which voltage values are input other than the maximum voltage value, or the switch element(s) corresponding to the electrode(s) to which voltage values are input other than the maximum and the minimum voltage values.

### BRIEF DESCRIPTION OF THE DRAWINGS

Exemplary embodiments of the present invention will be described in detail based on the following figures, wherein:

FIG. 1 shows a main-part configuration of an inkjet recording apparatus according to an exemplary embodiment of the invention;

FIG. 2 shows a schematic configuration of an inkjet recording head according to the exemplary embodiment of the invention;

FIG. 3 shows a configuration of a drive IC according to the exemplary embodiment of the invention;

FIG. 4 shows a detailed configuration of a driver;

FIG. 5 shows a detailed configuration of a selector and decoder;

FIG. 6 shows a state of the driver in a drive mode;

FIGS. 7A, 7B, and 7C show an example of a waveform set of the drive mode;

FIG. 8 shows a state of the driver in an analog drive mode;

FIGS. 9A, 9B, and 9C show an example of a waveform set of the analog drive mode;

FIG. 10 shows a driver on-state in a diagnostic mode; and

FIGS. 11A and 11B show an example of a waveform set of the diagnostic mode.

### DETAILED DESCRIPTION

An exemplary embodiment of the invention will be described in detail below with reference to the drawings. The exemplary embodiment is one in which the invention is applied to an inkjet recording apparatus.

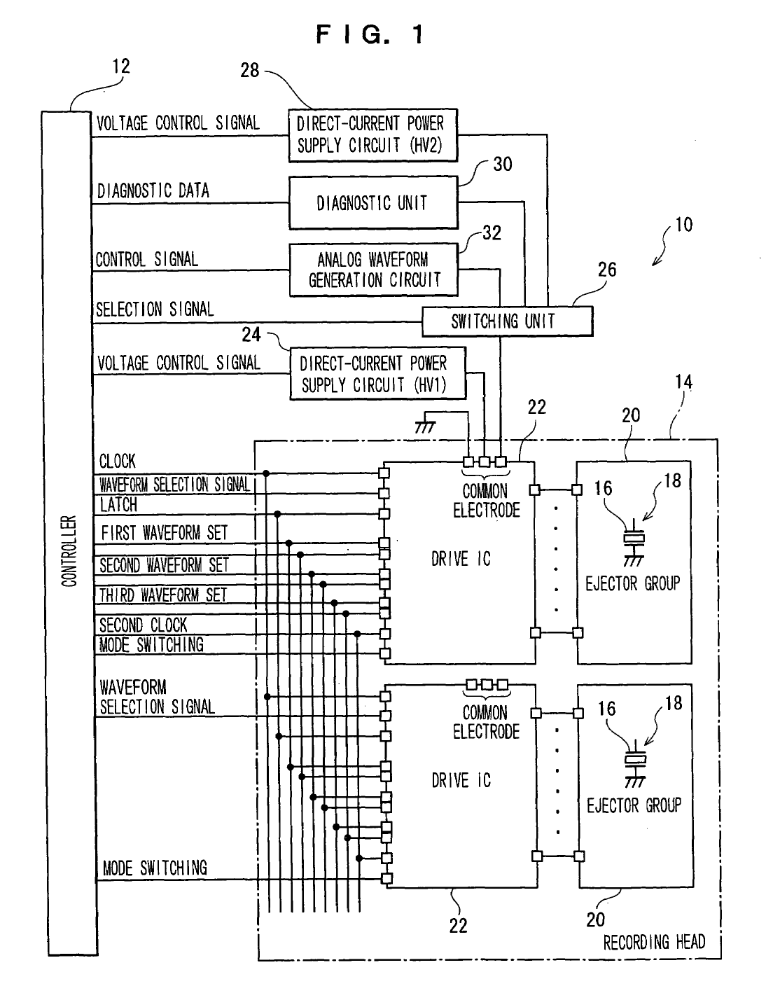

A configuration of the inkjet recording apparatus according to the exemplary embodiment of the invention will be described with reference to FIGS. 1 to 5.

FIG. 1 shows a main-part configuration of the inkjet recording apparatus 10 according to the exemplary embodiment of the invention. A sheet conveyance system is excluded in FIG. 1, and FIG. 1 mainly shows the configuration an inkjet recording head and surrounding parts thereof. As shown in FIG. 1, an inkjet recording apparatus 10 of the exemplary embodiment includes a controller 12 and an inkjet recording head 14. The controller 12 controls the whole operation of the inkjet recording apparatus 10, and the inkjet recording head 14 ejects an ink droplet based on supplied print data. The inkjet recording head 14 includes plural ejector groups 20 and drive ICs (Integrated Circuit) 22. The ejector group 20 is formed by arranging plural ejectors 18 in a two-dimensional manner, and the ejector 18 ejects the ink droplet by deforming an individually provided piezoelectric element 16. The drive IC 22 is provided corresponding to each ejector group 20.

The inkjet recording apparatus 10 of the exemplary embodiment is configured to include an actuator. The actuator includes a pressure generating chamber, an ink ejection port, a diaphragm, and the piezoelectric element 16. The pressure generating chamber is filled with ink. The ink ejection port is communicated with the pressure generating chamber, and the ink ejection port may eject the ink. The diaphragm constitutes a part of a wall surface of the pressure generating chamber, and the diaphragm is vibrated to expand and contract the pressure generating chamber. The piezoelectric element 16 is deformed by a voltage applied according to image data which expresses the image to be recorded, and thereby the piezoelectric element 16 vibrates the diaphragm.

All the drive ICs 22 provided in the inkjet recording head 14 is connected to the controller 12, and the controller 12 controls the operation of the drive IC 22 using a clock signal, a waveform selection signal, a latch signal, a first to third waveform setting signals, a mode switching signal, and the like.

The drive ICs 22 commonly use the clock signal, the waveform selection signal, the latch signal, the first to third waveform setting signals, and the mode switching signal. The waveform selection signal and the mode switching signal are independently inputted to each drive IC 22. In the waveform selection signal of the exemplary embodiment, a truth value 0 (00) indicates no waveform, a truth value 1 (01) indicates the first waveform set, a truth value 2 (10) indicates the second waveform set, and a truth value 3 (11) indicates the third waveform set.

The drive ICs 22 have a common electrode, and the common electrode is connected to a direct-current power supply circuit (HV1) 24, a switching unit 26, and a ground (GND). The direct-current power supply circuit (HV1) 24 is connected to the controller 12; and the switching unit 26 switches three kinds of connection points to lead the connection point to the drive IC 22.

The switching unit 26 switches a drive mode in which a rectangular waveform is driven, an analog drive mode in which an analog waveform is driven, and a diagnostic mode in which ejection characteristics or the likes of the ink droplet are diagnosed. The switching unit 26 is connected to a direct-current power supply circuit (HV2: HV1>HV2) 28, a diagnostic unit 30 which diagnoses the ejection characteristics or the likes, and an analog waveform generation circuit 32 which generates the analog voltage waveform. The switching unit 26 switches the three kinds of connection points according to a selection signal from the controller 12 to lead the connection point to the common electrode of the drive IC 22. A voltage control signal is inputted from the controller 12 to the direct-current power supply circuit (HV2) 28, diagnostic data and a control signal are inputted from the controller 12 to the diagnostic unit 30, and a reference waveform signal is inputted from the controller 12 to the analog waveform generation circuit 32.

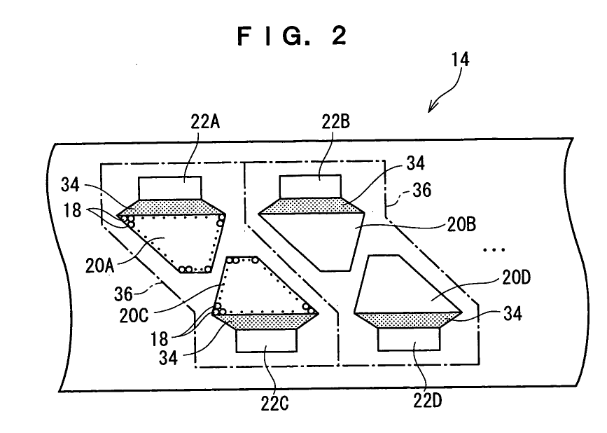

FIG. 2 shows a schematic configuration of the inkjet recording head 14 according to the exemplary embodiment of the invention.

As shown in FIG. 2, the plural ejector groups 20A, 20B, 20C, 20D . . . are arranged in the inkjet recording head 14 of the exemplary embodiment. Each unit structure of the ejector groups 20A, 20B, 20C, 20D . . . is formed by two-dimensionally arranging the plural ejectors 18, and plural unit structures are arranged such that parts of end portions of the ejector group arranged adjacent to each other overlap each other in a predetermined direction (lengthwise direction (longitudinal direction) of the inkjet recording head 14).

The drive ICs 22A, 22B, 22C, 22D . . . are provided one-on-one corresponding to the ejector groups 20A, 20B, 20C, 20D . . . , and the ejector group and the corresponding drive IC are electrically connected with each connection line 34. Hereinafter, sometimes the ejector groups 20A, 20B, 20C, 20D . . . are abbreviated to “ejector group 20” except as otherwise specifically shown. Similarly, sometimes the drive ICs 22A, 22B, 22C, 22D . . . are abbreviated to “drive IC 22” except as otherwise specifically shown.

In the ejector group 20 of the exemplary embodiment, an arrangement region is formed in a trapezoidal shape in which angles of two hypotenuses connecting upper and lower bases differ from each other. In the inkjet recording head 14 of the exemplary embodiment, a pair of ejector groups 20 is arranged such that the upper bases face each other with respect to a center line in the lengthwise direction of the inkjet recording head, the corresponding drive IC 22 is also integrally arranged, and thereby a head unit 36 is formed as a single component. The inkjet recording head 14 is formed while the plural head units 36 are arranged in the lengthwise direction.

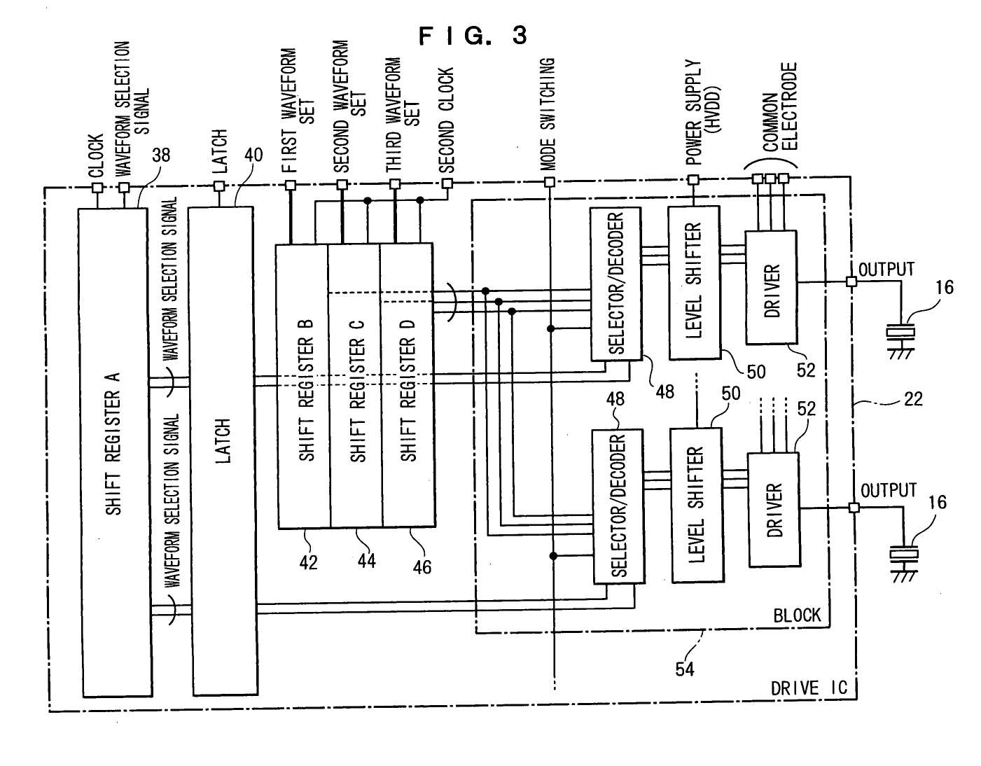

FIG. 3 shows a configuration of the drive IC 22 according to the exemplary embodiment of the invention.

As shown in FIG. 3, the drive IC 22 includes a shift register A38, a latch circuit 40, shift registers B42 to D46, a selector/decoder 48, a level shifter 50, and a driver 52.

The selector/decoder 48, the level shifter 50, and the driver 52 are provided in each piezoelectric element 16 and formed as a block 54 corresponding to the ejector group 20.

The clock signal and the waveform selection signal which are outputted from the controller 12 are inputted to the shift register A38, and the latch signal outputted from the controller 12 is inputted to the latch circuit 40.

The waveform selection signal is adopted to select any one (a pair of signals) of the first to third waveform setting signals, and the waveform selection signal is formed as serial data including the waveform signal and the waveform selection signal. The first waveform setting signal is inputted to the shift register B42, the second waveform setting signal is inputted to the shift register C44, and the third waveform setting signal is inputted to the shift register D46.

In the following description, a drive waveform is supplied to one piezoelectric element 16. The same hold to other piezoelectric elements 16, so that the description will be neglected for other piezoelectric elements 16.

The shift register A38 converts the waveform selection signal which is of the inputted serial data into parallel data to output the parallel data to the latch circuit 40.

The latch circuit 40 latches the parallel data, outputted from the shift register A38, according to the latch signal inputted from the controller 12.

The shift registers B42 to D46 shifts drive timing in each block 54 of the ejector group 20. The exemplary embodiment has the 512 trapezoidal ejector groups 20, the 512 trapezoidal ejector groups 20 is divided into 32 blocks, and the block includes the 16 ejectors 18. The number of stages of the shift registers B42 to D46 is set at the number of blocks (32), and the drive timing of each block 54 is shifted by two clocks. For example, a shift time is set at 0.1 μs at a frequency of 10 MHz, and the total shift times become 3.2 μs (drive time≧20 μs).

The first to third waveform setting signals are inputted from the controller 12 to the selector/decoder 48 through the shift registers B42 to D46, and the parallel data of the waveform selection signal latched by the latch circuit 40 is inputted to a selector terminal. Accordingly, the selector/decoder 48 selects and outputs the waveform setting signal which is directed by the waveform selection signal from the first to third waveform setting signals.

The selector/decoder 48 has a function of correcting the driver control signal according to the diagnostic result of the diagnostic mode. The diagnostic mode is a mode in which the ejection characteristics of each ejector are diagnosed when each ejector is driven by a predetermined waveform. For example, the voltage waveform applied to the piezoelectric element 16 is diagnosed in the diagnostic mode.

The selector/decoder 48 is connected to the level shifter 50, and the level shifter 50 outputs the waveform setting signal after performing level conversion to the waveform setting signal outputted from the selector/decoder 48. Electric power having a predetermined voltage level (predetermined level not lower than 40 V in the exemplary embodiment) HVDD is supplied to the level shifter 50 from a power supply (not shown), and the level shifter 50 performs the level conversion of amplitude of the waveform setting signal selected by the waveform selection signal into the voltage level HVDD. An already existing level shifter may be used as the level shifter 50.

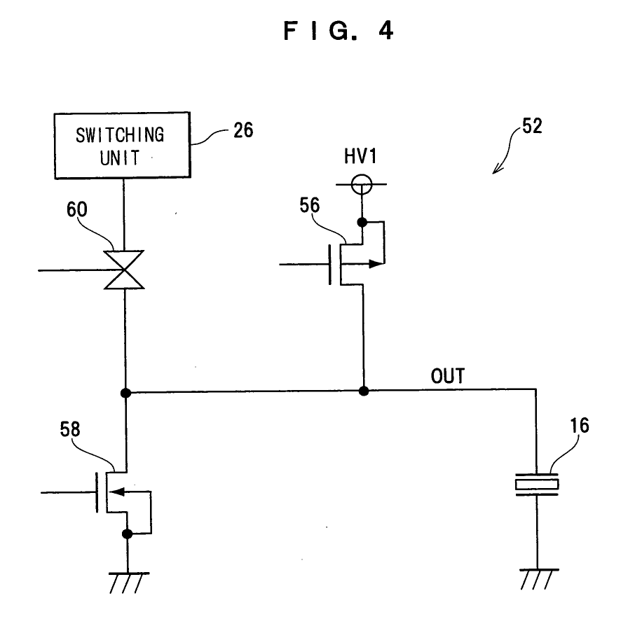

FIG. 4 shows a detailed configuration of the driver 52.

As shown in FIG. 4, the driver 52 of the exemplary embodiment includes two unidirectional switch elements (PMOS and NMOS) 56 and 58 and one bidirectional switch element (for example, CMOS transmission gate) 60.

A source terminal of the PMOS unidirectional switch element 56 is connected to the direct-current power supply circuit (HV1) 24 through common electrode, a source terminal of the NMOS unidirectional switch element 58 is connected to the ground through the common electrode, and a terminal which becomes a source or a drain of the bidirectional switch element 60 is connected to the switching unit 26 through the common electrode.

Drain terminals of the two unidirectional switch elements 56 and 58 and the other source or drain of the bidirectional switch element 60 are connected to the piezoelectric element 16 whose one end is grounded.

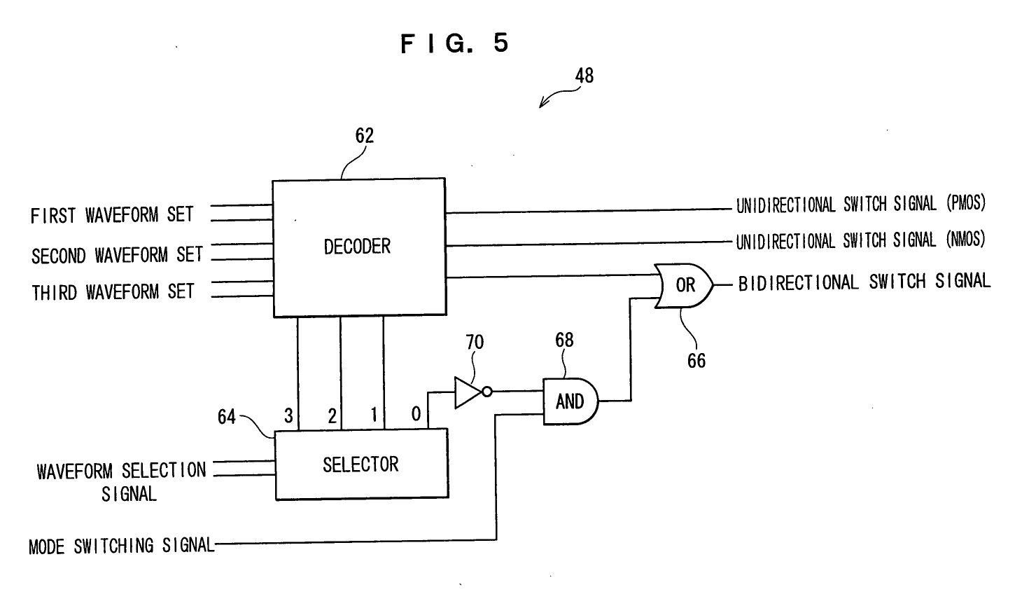

FIG. 5 shows a detailed configuration of the selector/decoder 48.

As shown in FIG. 5, the selector/decoder 48 includes a decoder 62, a selector 64, and a logic operation circuit. The logic operation circuit includes an OR circuit 66, an AND circuit 68, and an inverting circuit 70.

The waveform selection signal is inputted to the selector 64. In the exemplary embodiment, the selector 64 outputs the signal (signal for selecting any one of the first to third waveform sets) of the truth values 0 to 3 to the decoder 62 in the case where the first to third waveform sets are selected, and the selector 64 outputs 0 (“L” output) to the AND circuit 68 through the inverting circuit 70 in the diagnostic mode.

The mode switching signal is inputted to the AND circuit 68, and the output of the AND circuit 68 is inputted to the OR circuit 66. In the mode switching signal of the exemplary embodiment, “H” is outputted in the diagnostic mode, and “L” is outputted in the drive mode.

The output of the decoder 62 is connected to the two unidirectional switch elements 56 and 58, and the output of the decoder 62 is also connected to the bidirectional switch element 60 through the OR circuit 66.

That is, in the drive mode in which each ejector 18 is driven, the mode switching signal becomes “L”, the output of the AND circuit 68 becomes “L”, and the output of the OR circuit 66 becomes the output of the decoder 62. Accordingly, each switch element of the driver 52 is controlled by the output of the decoder 62 so as to become the waveform set selected by the waveform selection signal.

In the diagnostic mode, for the ejector 18 which is of a diagnostic target, the selector 64 outputs “0”, i.e., “L”, and the inverting circuit 70 outputs “H” to the AND circuit 68. In the diagnostic mode, because the mode switching signal of “H” is outputted, the output of the AND circuit 68 becomes “H” to forcibly turn on the bidirectional switch element 60. This enables the waveform applied to the piezoelectric element 16 through the bidirectional switch element 60 to be diagnosed. For the ejectors 18 except for the diagnostic target, the selector 64 outputs “0” and the inverting circuit 70 outputs “H” to the AND circuit 68. Because the mode switching signal is in the “L” state, the output of the AND circuit 68 becomes “L”, and the output of the OR circuit 66 becomes the output of the decoder 62.

Then, action of the inkjet recording apparatus 10 according to the exemplary embodiment of the invention having the above configuration will be described.

The drive mode in which the rectangular waveform is applied to the piezoelectric element 16 to eject the ink droplet from each ejector 18 will be described.

In the drive mode, the controller 12 controls the switching unit 26 with the selection signal to connect the direct-current power supply circuit (HV2) 28 and the common electrode of the drive IC 22. At this point, controller 12 outputs the voltage control signal to the direct-current power supply circuit (HV2) 28 to control the direct-current power supply circuit (HV2) 28.

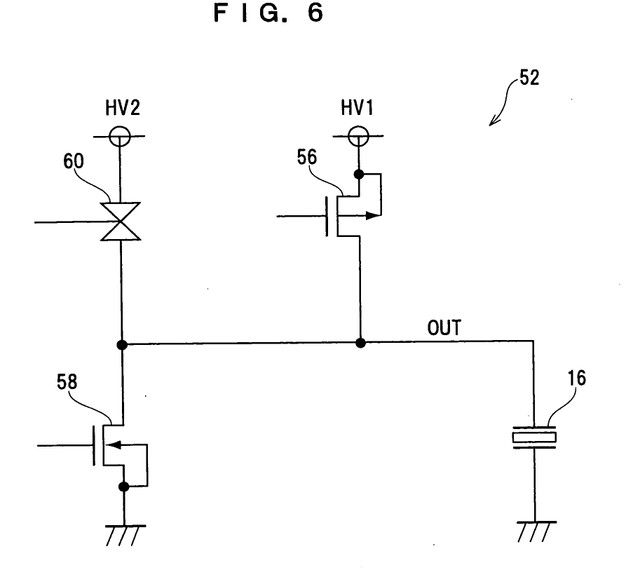

As shown in FIG. 6, in the driver 52, a potential HV2 from the direct-current power supply circuit is applied to the bidirectional switch element 60. The source terminal of the unidirectional switch element 56 is connected to the direct-current power supply circuit (HV1) 24, and the source terminal of the unidirectional switch element 58 is connected to GND. Therefore, the rectangular pulse waveform having the voltage levels of three values (0, HV1, and HV2) may be applied to the piezoelectric element 16 by exclusively turning on each switch element.

On the other hand, when the clock signal, the waveform selection signal, the latch signal, the first to third first to third waveform setting signals, the second clock signal, and the mode switching signal are inputted to each drive IC 22, the waveform selection signal which is of the serial data inputted by the shift register A38 is converted into the parallel data, and the parallel data is outputted to the latch circuit 40. The parallel data outputted from the shift register A38 by the latch circuit 40 is latched according to the latch signal inputted from the controller 12, and the parallel data is outputted to the shift registers B42 to D46.

The drive timing of the first to third waveform sets inputted to the shift registers B42 to D46 is shifted in each block 54 of the ejector group 20 by the shift registers B42 to D46, and the first to third waveform sets are outputted to the selector/decoder 48.

In the selector/decoder 48, the first to third waveform setting signals are inputted from the controller 12 to the decoder 62 through the shift registers B42 to D46, and the parallel data of the waveform selection signal latched by the latch circuit 40 is inputted to the selector 64.

At this point, in the case where the mode switching signal is the drive mode, “L” is inputted to the AND circuit 68, the AND circuit 68 becomes “L”, and the output of the OR circuit 66 becomes the output of the decoder 62. Accordingly, each switch element of the driver 52 is controlled by the output of the decoder 62 so as to become the waveform set selected by the waveform selection signal.

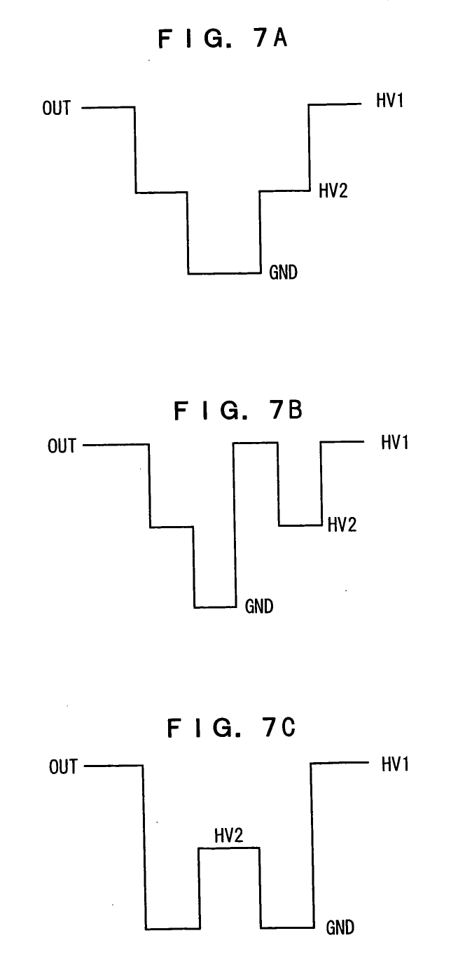

It is assumed that the truth value “0” (00) of the waveform set turns off all the switch elements of the driver 52, the truth value “1” (01) turns on the unidirectional switch element 58 (GND), the truth value “2” (10) turns on the unidirectional switch element 56 (HV1), and the truth value “3” (11) turns on the bidirectional switch element 60 (HV2). It is also assumed that the first waveform set is formed as shown in FIG. 7A (truth value 2→3→1→3→2), the second waveform set is formed as shown in FIG. 7B (truth value 2→3→1→2→3→2), and the third waveform set is formed as shown in FIG. 7C (truth value 2→1→3→1→2). In this case, each switch element of the driver 52 is controlled according to each waveform set, and the voltage waveform is applied to the piezoelectric element 16 according to the waveform set. Accordingly, the ink droplet is ejected from each ejector 18 according to the waveform applied to the piezoelectric element 16.

In the case where the unidirectional switch element 56 (HV1) is turned on, HV1 is larger than HV2 when a switch element equivalent of the unidirectional switch element 56 is used instead of the bidirectional switch element 60. Therefore, although the control signal for turning off the switch element equivalent of the unidirectional switch element 56 is inputted, in a path of power supply HV1—the unidirectional switch element 56—the switch element equivalent of the unidirectional switch element 56—and power supply HV2, the leakage current is increased or the short circuit is generated in the worst case, which possibly results in the breakage of the drive IC 22. However, the bidirectional switch element 60 is used in the exemplary embodiment, and the turn-on and turn-off may be performed by the inputted control signal irrespective of the voltage applied to each terminal of the bidirectional switch 60. Therefore, the increase in leakage current may be suppressed and the generation of the short circuit may be prevented.

In the exemplary embodiment, the bidirectional switch occupying a larger area is not applied to all the switch elements, but the bidirectional switch is applied to a part of the switch elements. Therefore, upsizing the drive IC 22 may be suppressed to a minimum, and cost reduction may be achieved.

In the exemplary embodiment, a start value and an end value of a waveform set drive period are equalized to each other, the serial input is adopted, and the truth value “2” is set at the start value and the end value. The invention is not limited to the exemplary embodiment. For example, the waveform set in which the start value and the end value are set at the truth value “1” or “3” may be used. A minimum voltage maintaining time becomes the block drive shift time. For example, the minimum voltage maintaining time becomes 0.1 μs. When the voltage maintaining time is shortened, sometimes discharge does not occur until the voltage reaches a predetermined value. Therefore, the short voltage maintaining time may actively be utilized such that the charge and discharge amplitudes are decreased.

Then, the analog drive mode in which the analog waveform is applied to the piezoelectric element 16 to eject the ink droplet from each ejector 18 will be described.

In the analog drive mode, the controller 12 controls the switching unit 26 with the selection signal, and the analog waveform generation circuit 32 and the common electrode of the drive IC 22 are connected to each other. At this point, the controller 12 outputs the control signal to the analog waveform generation circuit 32 to control the analog waveform generation circuit 32.

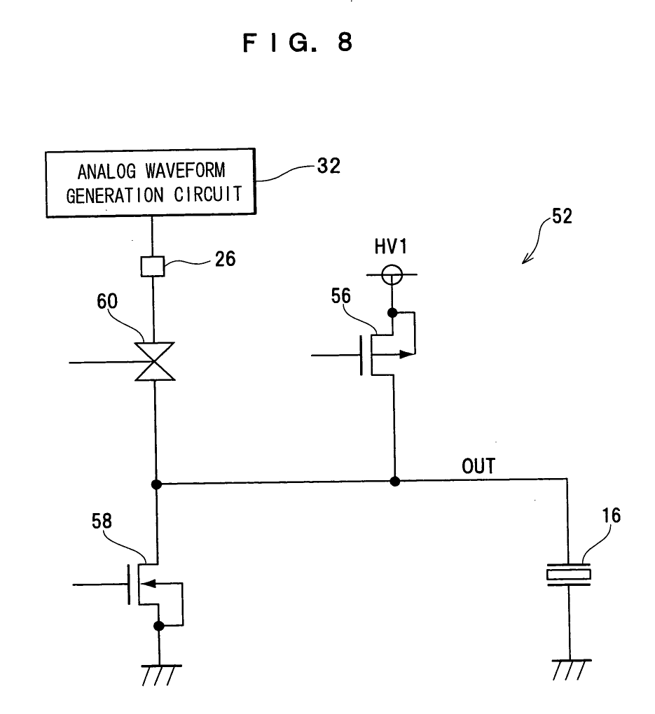

As shown in FIG. 8, in the driver 52, the analog waveform generated by the analog waveform generation circuit 32 is applied to the bidirectional switch element 60. The source terminal of the unidirectional switch element 56 is connected to the direct-current power supply circuit (HV1) 24, and the source terminal of the unidirectional switch element 58 is connected to GND. Therefore, the voltage level including only the analog waveform or a combination of the analog waveform and the rectangular waveform may be applied to the piezoelectric element 16 by exclusively turning on each switch element.

In the selector and decoder 48, the first to third waveform setting signals are inputted from the controller 12 to the decoder 62 through the shift registers B42 to D46, and the parallel data of the waveform selection signal latched by the latch circuit 40 is inputted to the selector 64.

At this point, in the analog drive mode, similarly to the drive mode, the mode switching signal of “L” is inputted to the AND circuit 68, the AND circuit 68 becomes “L”, and the output of the OR circuit 66 becomes the output of the decoder 62. Accordingly, each switch element of the driver 52 is controlled by the output of the decoder 62 so as to become the waveform set selected by the waveform selection signal.

It is assumed that the truth value “0” (00) of the waveform set turns off all the switch elements of the driver 52, the truth value “1” (01) turns on the unidirectional switch element 58 (GND), the truth value “2” (10) turns on the unidirectional switch element 56 (HV1), and the truth value “3” (11) turns on the bidirectional switch element 60 (analog waveform). In this case, the waveform set in which the rectangular waveform and the analog waveform are combined may be generated. The waveform set which is driven only by the analog waveform may also be generated.

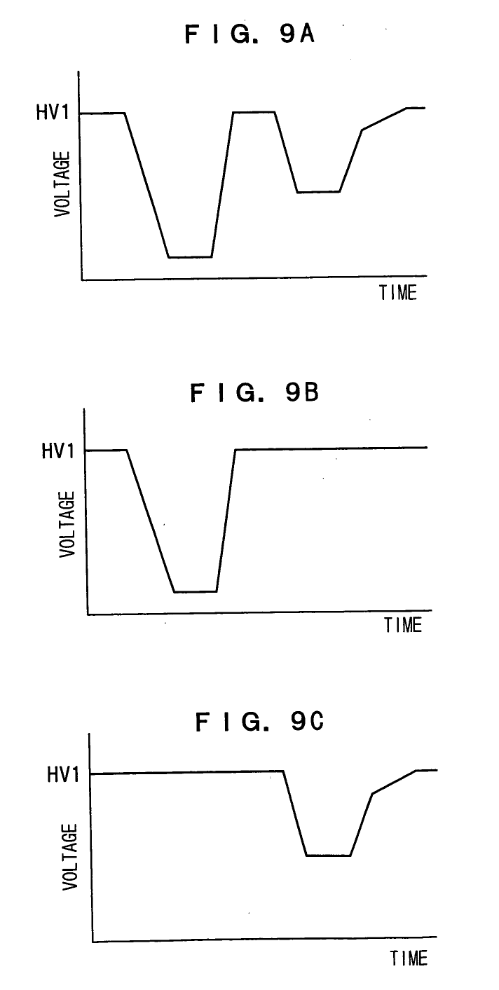

FIG. 9 shows an example of the analog waveform set. It is assumed that the first analog waveform set is formed as shown in FIG. 9A (always truth value 3), the second analog waveform set is formed as shown in FIG. 9B (truth value 3→0), and the third analog waveform set is formed as shown in FIG. 9C (truth value 0→3). In this case, each switch element of the driver 52 is controlled according to each waveform set, and the voltage is applied to the piezoelectric element 16 according to the waveform set. Accordingly, the ink droplet is ejected from each ejector 18 according to the waveform applied to the piezoelectric element 16. The analog waveform drive may be performed as described above, so that the liquid level may freely be controlled and the droplet ejection characteristics from the ejector 18 may freely be controlled.

Thus, because the bidirectional switch element 60 is used in the exemplary embodiment, the analog waveform may also applied to the piezoelectric element 16 and a gradation range may be widened.

The waveform set in which the rectangular waveform and the analog waveform are combined may be generated, and the waveform set which is driven only by the analog waveform may be generated, so that both the rectangular waveform drive and the analog waveform drive become compatible.

In the analog waveform, the analog waveform is common for one drive IC 22, and the collective drive is performed because the drive timing can not be shifted in each block 54 unlike the pulse drive. Therefore, it is necessary to set the start point of the waveform by previously considering the block drive shift time. For example, in the case of the total shift time of 3.2 μs, the start point of the waveform is shifted not lower than 3.2 μs (corresponding to a delay time for the latch).

The plural analog waveforms may be arranged in time series. This case is not suitable to speed-up because the drive period is lengthened. Therefore, a few analog waveforms are appropriately arranged in time serried. For example, in the two analog waveforms, any one of “truth value 3”, “truth value 3→0”, and “truth value 0→3” may be used as the waveform set.

Then, the diagnostic mode in which the ejection characteristics of each ejector 18 are diagnosed will be described.

In the diagnostic mode, the controller 12 controls the switching unit 26 with the selection signal, and the diagnostic unit 30 and the common electrode of the drive IC 22 are connected. At this point, the controller 12 outputs the diagnostic data to the diagnostic unit 30 to control the diagnostic unit 30.

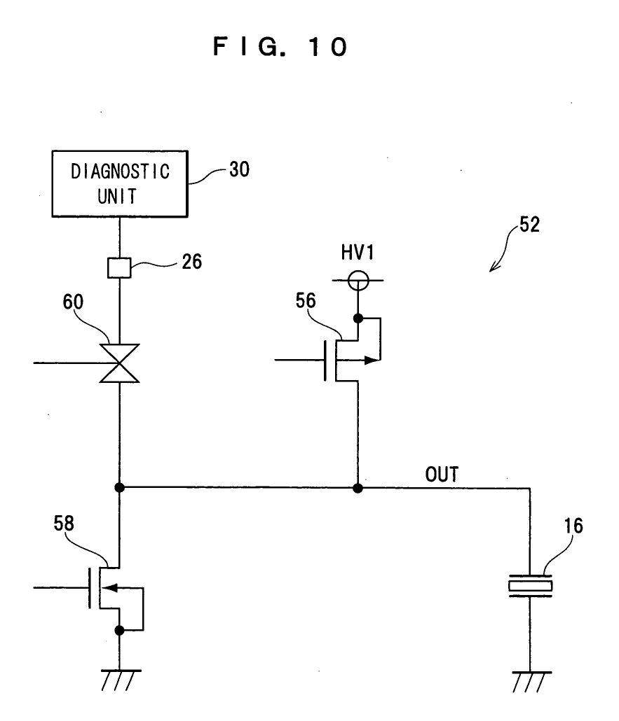

As shown in FIG. 10, in the driver 52, the diagnostic unit 30 is connected to a terminal which becomes the source or the drain of the bidirectional switch element 60. The source terminal of the unidirectional switch element 56 is connected to the direct-current power supply circuit (HV1) 24, and the source terminal of the unidirectional switch element 58 is connected to GND. The diagnostic unit 30 may detect characteristics of the voltage applied to the piezoelectric element 16 to diagnose the ejection characteristics of each ejector 18 by controlling the turn-on and turn-off of each switch element (for example, the unidirectional switches 56 and 58 are exclusively turned on while the bidirectional switch 60 is turned on).

In the selector and decoder 48, the first to third waveform setting signals are inputted from the controller 12 to the decoder 62 through the shift registers B42 to D46, and the parallel data of the waveform selection signal latched by the latch circuit 40 is inputted to the selector 64.

At this point, in the diagnostic mode, the mode switching signal of “H” is inputted to the AND circuit 68, the AND circuit 68 becomes “H”, and the output of the OR circuit 66 becomes “H”. Therefore, the bidirectional switch element 60 is turned on, and the bidirectional switch element 60 functions as the output terminal.

It is assumed that the truth value “0” (00) of the waveform set turns off all the switch elements of the driver 52, the truth value “1” (01) turns on the unidirectional switch element 58 (GND), the truth value “2” (10) turns on the unidirectional switch element 56 (HV1), and the truth value “3” (11) is not used to cause the bidirectional switch element 60 to function as the output terminal. In this case, the characteristics of the voltage applied to each piezoelectric element 16 may be diagnosed.

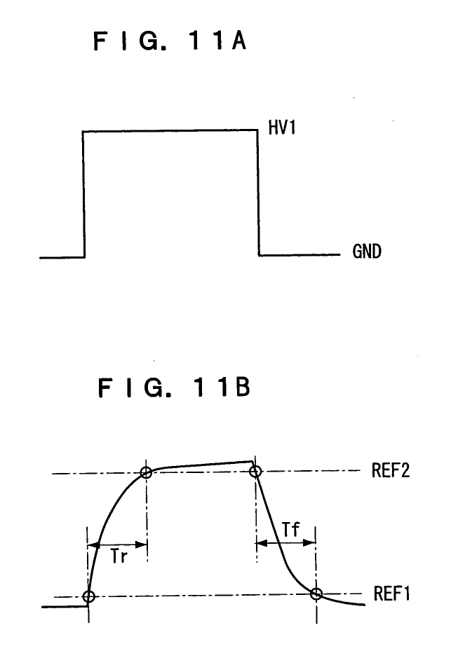

The diagnostic waveform (truth value 1→2→1) shown in FIG. 11A may be applied as the diagnostic waveform set. In this case, because the output waveform shown in FIG. 11B is inputted to the diagnostic unit 30, the diagnostic unit 30 may obtained the actually dull waveform applied to the piezoelectric element 16. Therefore, a rise time (Tr) or a fall time (Tf) of the waveform is measured to perform feedback to the controller 12, and thereby the fluctuation in droplet ejected from each ejector 18 may be corrected.

Although the terminal connected to the diagnostic unit 26 of the bidirectional switch element is caused to function as the output terminal in the diagnostic mode of the exemplary embodiment, the invention is not limited to the exemplary embodiment. For example, the terminal connected to the diagnostic unit 26 of the bidirectional switch element is caused to function as an input and output terminal and a measuring instrument such as an impedance analyzer may be connected as the diagnostic unit.

In this case, the selector/decoder 48 is operated as with the diagnostic mode, and the diagnostic unit 26 and the waveform set are different from those of the diagnostic mode.

That is, in the waveform selection signal, the waveform set which is previously set for the diagnosis is selected for the target ejector 18. For example, a predetermined waveform set except for 0 is used as the diagnostic waveform, and no waveform “0” set at the ejector 18 which is not the diagnostic target. In the diagnostic mode, the truth value “3” is not used for the predetermined waveform set. However, in the waveform set which always selects the truth value “3”, the unidirectional switch elements 56 and 58 may be turned off while only the bidirectional switch element 60 is turned on. Therefore, the terminal connected to the diagnostic unit 26 of the bidirectional switch element may be caused to function as the input and output terminal, and disturbance factors inputted from the unidirectional switch elements 56 and 58 may be removed to utilize only the common electrode connected to the bidirectional switch element. Accordingly, various measuring instruments may be connected as the diagnostic unit 26 to perform various diagnoses.

For example, various characteristics except for the time constant, such as an intrinsic period of the ejector (liquid chamber resonance frequency) and characteristics (electrostatic capacitance, dielectric loss, resonance frequency, and the like) of the piezoelectric element 16, may correctly be measured by connecting the measuring instrument such as the impedance analyzer as the diagnostic unit 26.

In the exemplary embodiment, the unidirectional switch elements 56 and 58 are used as the switch element corresponding to the common electrode which applies the maximum and minimum voltages, and the bidirectional switch element 60 is used as the switch element corresponding to the common electrode which applies the intermediate voltage between the maximum and minimum voltages. However, the bidirectional switch element may be used as the switch element corresponding to the common electrode which applies the minimum voltage.

Although the three switch elements are used in the exemplary embodiment, the invention is not limited to the exemplary embodiment. For example, at least four switch elements may be used. In the case where at least four switch elements are used, the switch element corresponding to the common electrode which applies the voltage except for the maximum voltage or the switch element corresponding to the common electrode which applies the voltage except for the maximum and minimum voltages may become the bidirectional switch element.

Although the capacitive device is used as the piezoelectric element in the exemplary embodiment, the invention is not limited to the exemplary embodiment. For example, the same effect is obtained when an electrostatic actuator is used instead of the piezoelectric element. In the electrostatic actuator, one of electrodes facing each other is formed by an elastic electrode, and displacement of the elastic electrode by electrostatic force is utilized.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. A droplet ejection head drive apparatus comprising:
a capacitive device for ejecting a droplet;
a plurality of electrodes to which at least three kinds of voltage values are inputted;
a plurality of switch elements that are provided corresponding to each of the electrodes, the plurality of switch elements applying the voltage values to the capacitive device, and in the plurality of switch elements bidirectional switch element(s) are used for at least one of either
the switch elements corresponding to the electrodes to which voltage values are input other than the maximum voltage value, or
the switch element(s) corresponding to the electrode(s) to which voltage values are input other than the maximum and the minimum voltage values.

2. A droplet ejection head drive apparatus according to claim 1, wherein the plurality of electrodes include a first electrode that is grounded, a second electrode to which a first direct-current power supply circuit is connected, the first direct-current power supply circuit generating a first voltage value which is of a predetermined voltage value, and a third electrode to which a second direct-current power supply circuit is connected, the second direct-current power supply circuit generating a second voltage value larger than the first voltage value, and
unidirectional switch elements are used as the switch elements corresponding to the first electrode and the third electrode, and a bidirectional switch element is used as the switch element corresponding to the second electrode.

3. A droplet ejection head drive apparatus according to claim 1, further comprising an analog waveform generation circuit that generates an analog voltage waveform,
wherein the analog waveform generation circuit is connected to one of the electrodes corresponding to one of the bidirectional switch element(s).

4. A droplet ejection head drive apparatus according to claim 1, wherein the capacitive device includes a piezoelectric element.

5. A droplet ejection head drive apparatus according to claim 1, wherein the bidirectional switch element includes a CMOS.

6. A droplet ejection head drive apparatus according to claim 2, wherein the unidirectional switch elements include at least one of a PMOS or an NMOS.

7. A droplet ejection head drive apparatus according to claim 2, further comprising a switching unit that is provided between the first direct-current power supply circuit and the second electrode, the switching unit switching a connection point connected to the second electrode among destinations of the first direct-current power supply circuit, the analog waveform generation circuit that generates the analog voltage waveform, and a diagnostic unit that diagnoses the voltage applied to the capacitive device.

8. A droplet ejection head drive apparatus according to claim 7, wherein when the switching unit switches the connection point to the first direct-current power supply circuit a rectangular waveform including voltage levels of three values is applied to the capacitive device by exclusively turning on the plurality of switch elements, when the switching unit switches the connection point to the analog waveform generation circuit at least one waveform of a rectangular waveform including voltage level of two values or an analog voltage waveform is applied to the capacitive device by exclusively turning on the plurality of switch elements, and when the switching unit switches the connection point to the diagnostic unit the diagnostic unit diagnoses the voltage waveform applied to the capacitive device by exclusively turning on the unidirectional switch elements while the bidirectional switch element is turned on.

9. A droplet ejection head drive apparatus according to claim 2, further comprising a switching unit that is provided between the first direct-current power supply circuit and the second electrode, the switching unit switching a connection point connected to the second electrode between destinations of the first direct-current power supply circuit and a diagnostic unit that diagnoses the voltage applied to the capacitive device, and
wherein when the switching unit switches the connection point to the first direct-current power supply circuit a rectangular waveform including voltage levels of three values is applied to the capacitive device by exclusively turning on the plurality of switch elements, and when the switching unit switches the connection point to the diagnostic unit the diagnostic unit diagnoses the voltage waveform applied to the capacitive device by exclusively turning on the unidirectional switch elements while the bidirectional switch element is turned on.

10. A droplet ejection head drive apparatus comprising:
a capacitive device for ejecting a droplet;
a first electrode that is grounded;
a second electrode to which a first direct-current power supply circuit is connected, the first direct-current power supply circuit generating a first voltage value which is of a predetermined voltage value;
a third electrode to which a second direct-current power supply circuit is connected, the second direct-current power supply circuit generating a second voltage value that is larger than the first voltage value;
unidirectional switch elements that correspond to each of the first electrode and the third electrode to apply the respective voltage values to the capacitive device; and
a bidirectional switch element that corresponds to the second electrode to apply the respective voltage value to the capacitive device.

11. A droplet ejection head drive apparatus according to claim 10, further comprising a switching unit that is provided between the first direct-current power supply circuit and the second electrode, the switching unit switching a connection point connected to the second electrode among destinations of the first direct-current power supply circuit, an analog waveform generation circuit that generates an analog voltage waveform, and a diagnostic unit that diagnoses the voltage applied to the capacitive device.

12. A droplet ejection head drive apparatus according to claim 11, wherein when the switching unit switches the connection point to the first direct-current power supply circuit a rectangular waveform including voltage levels of three values is applied to the capacitive device by exclusively turning on the unidirectional switch elements and the bidirectional switch element, when the switching unit switches the connection point to the analog waveform generation circuit at least one waveform of a rectangular waveform including voltage levels of two values or an analog voltage waveform is applied to the capacitive device by exclusively turning on the unidirectional switch elements and the bidirectional switch element, and when the switching unit switches the connection point to the diagnostic unit the diagnostic unit diagnoses the voltage waveform applied to the capacitive device by exclusively turning on the unidirectional switch elements while the bidirectional switch element is turned on.

13. A droplet ejection head drive apparatus according to claim 10, further comprising a switching unit that is provided between the first direct-current power supply circuit and the second electrode, the switching unit switching a connection point connected to the second electrode between destinations of the first direct-current power supply circuit and a diagnostic unit that diagnoses the voltage applied to the capacitive device, and
wherein when the switching unit switches the connection point to the first direct-current power supply circuit a rectangular waveform including voltage levels of three values is applied to the capacitive device by exclusively turning on the unidirectional switch elements and the bidirectional switch element, and when the switching unit switches the connection point to the diagnostic unit the diagnostic unit diagnoses the voltage waveform applied to the capacitive device by exclusively turning on the unidirectional switch elements while the bidirectional switch element is turned on.

14. An inkjet recording apparatus including a droplet ejection head drive apparatus comprising:
a capacitive device for ejecting a droplet;
a plurality of electrodes to which at least three kinds of voltage values are input;
a plurality of switch elements that are provided corresponding to each of the electrodes, the plurality of switch elements applying the voltage values to the capacitive device, and in the plurality of switch elements bidirectional switch element(s) are used for at least one of either
the switch elements corresponding to the electrodes to which voltage values are input other than the maximum voltage value or
the switch element(s) corresponding to the electrode(s) to which voltage values are input other than the maximum and the minimum voltage values.

15. An inkjet recording apparatus according to claim 14, wherein the plurality of electrodes include a first electrode that is grounded, a second electrode to which a first direct-current power supply circuit is connected, the first direct-current power supply circuit generating a first voltage value which is of a predetermined voltage value, and a third electrode to which a second direct-current power supply circuit is connected, the second direct-current power supply circuit generating a second voltage value larger than the first voltage value, and
unidirectional switch elements are used as the switch elements corresponding to the first electrodes and the third electrodes, and a bidirectional switch element is used as the switch element corresponding to the second electrode.

16. An inkjet recording apparatus according to claim 14, wherein the droplet ejection head drive apparatus further comprises an analog waveform generation circuit that generates an analog voltage waveform,
wherein the analog waveform generation circuit is connected to the electrode corresponding to the bidirectional switch element.

17. An inkjet recording apparatus according to claim 15, wherein the droplet ejection head drive apparatus further comprises a switching unit that is provided between the first direct-current power supply circuit and the second electrode, the switching unit switching a connection point connected to the second electrode among destinations of the first direct-current power supply circuit, an analog waveform generation circuit that generates an analog voltage waveform, and a diagnostic unit that diagnoses the voltage applied to the capacitive device.

18. An inkjet recording apparatus according to claim 17, wherein when the switching unit switches the connection point to the first direct-current power supply circuit a rectangular waveform including voltage levels of three values is applied to the capacitive device by exclusively turning on the plurality of switch elements, when the switching unit switches the connection point to the analog waveform generation circuit at least one waveform of a rectangular waveform including voltage level of two values or an analog voltage waveform is applied to the capacitive device by exclusively turning on the plurality of switch elements, and when the switching unit switches the connection point to the diagnostic unit the diagnostic unit diagnoses the voltage waveform applied to the capacitive device by exclusively turning on the unidirectional switch elements while the bidirectional switch element is turned on.

19. An inkjet recording apparatus according to claim 15, wherein the droplet ejection head drive apparatus further comprises a switching unit that is provided between the first direct-current power supply circuit and the second electrode, the switching unit switching a connection point connected to the second electrode between destinations of the first direct-current power supply circuit and a diagnostic unit that diagnoses the voltage applied to the capacitive device, and
wherein when the switching unit switches the connection point to the first direct-current power supply circuit a rectangular waveform including voltage levels of three values is applied to the capacitive device by exclusively turning on the plurality of switch elements, and when the switching unit switches the connection point to the diagnostic unit the diagnostic unit diagnoses the voltage waveform applied to the capacitive device by exclusively turning on the unidirectional switch elements while the bidirectional switch element is turned on.
